(19) United States
(12) Patent Application Publication
(10) Pub. No.: US 2007/0067652 A1
(43) Pub. Date: Mar. 22, 2007

(54) System using bus arbiter to power down

(75) Inventor: Kenji Asai, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD.

(21) Appl. No.: 11/474,445

(22) Filed: Jun. 26, 2006

(30) Foreign Application Priority Data
Aug. 22, 2005 (JP) 2005-239546

(51) Int. Cl. G06F 1/00

(52) U.S. Cl. 713/300

(57) ABSTRACT

A system operating in a normal mode and a power-saving mode includes a memory and one or more master modules interconnected by a bus. A bus arbiter selectively grants use of the bus to the master modules, and activates an enable signal when no master module is using the bus. A power-down module receives the enable signal and responds by performing processing to take the system from the normal mode to the power-saving mode. The system can therefore save power effectively by switching promptly into the power-saving mode during even short intervals of bus inactivity.

### BACKGROUND OF THE INVENTION

1. Field of the Invention

The present invention relates to a system including one or more master modules connected to an arbitrated bus and more particularly to a system designed to save power.

2. Description of the Related Art

A conventional system of this type is illustrated in FIG. 6. The system 100 includes two master modules 101, 102, a shared memory 103, a common bus 104, and a bus arbiter 105.

The master modules 101, 102 output respective bus request signals S11, S13 to the bus arbiter 105; the bus arbiter 105 outputs corresponding bus grant signals S12, S14 to the master modules 101, 102. The shared memory 103 sends the bus arbiter 105 an access information signal S15 indicating whether memory access is currently in progress. Memory access and other operations of the master modules and bus arbiter are synchronized with a clock signal.

The master modules 101, 102 output the bus request signals S11, S13 only when they need to use the common bus 104. The bus arbiter 105 outputs a bus grant signal granting the common bus 104 to the highest-priority master module requesting it, selected according to criteria described below. The master module that receives the bus grant signal can use the common bus 104 to access the shared memory 103. The shared memory 103 outputs the access information signal S15 continuously while being accessed.

The bus arbiter 105 outputs the bus grant signals S12, S14 according to the following criteria:

1) When only bus request signal S11 is active, bus grant signal S12 is output.

2) When bus request signal S13 is active, bus grant signal S14 is output, regardless of the state of bus request signal S11.

3) When the memory is being accessed by a master module (while the access information signal S15 is active), however, the above criteria 1) and 2) are not tested or acted on until the access is completed.

The power-saving mode is used to reduce power consumption by slowing or halting the operation of individual modules or the whole system 100. Bus activity and system status are monitored by software or other means to determine when the power-saving mode can be entered. The monitoring function may be carried out by one of the master modules, which acts as the system control module. If master module 101 is the system control module, then master module 101 always operates, but when it has no task to perform that requires memory access and decides from the inactivity of the bus 104 and possibly other factors that the power-saving mode can be entered, it obtains the bus right, carries out necessary preparatory processing, and then places the system in the power-saving mode while still retaining the bus right. The system cannot enter the power-down mode while master module 102 has the bus right.

While the system is in the power-saving mode, the access right to the common bus 104 belongs exclusively to master module 101, but the bus is not used, and to save power, the clock frequency is reduced.

Master module 101 also controls the recovery from the power-saving mode. This occurs when, for example, master module 101 receives an external interrupt, or master module 102 activates bus request signal S13. In the latter case, master module 101 performs necessary preparatory processing, then deactivates bus request signal S11 to release the common bus 104, enabling the bus access right to be transferred to master module 102. Master module 101 must monitor bus request signal S13 during the power-saving mode.

FIG. 7 is a timing waveform diagram illustrating the operation of the system 100. The illustrated operation will be described below.

Both master modules 101 and 102 output bus request signals S11 and S13 (at the active or high logic level) at time t₁. The bus arbiter 105 activates bus grant signal S14 at time t₂, giving the bus right to master module 102, which has higher priority. Having acquired the bus, master module 102 performs necessary operations such as memory access until time t₃, then resets bus request signal S13 to the low logic level. The access information signal S15 (not shown) which is active while the shared memory 103 is being accessed, becomes inactive by time t₃.

In response to the S13 signal transition at time t₃, at time t₄ the bus arbiter 105 deactivates bus grant signal S14 (by setting it to the low logic level), and outputs bus grant signal S12 to master module 101, which is still holding bus request signal S11 at the active (high) level.

Assume now that master module 101 has determined that the system can enter the power-saving mode. When master module 101 obtains the bus right at time t₄, it starts the processing necessary to place the system in the power-saving mode. This processing includes, for example:

1) commanding a system clock control module (not shown) that supplies a system clock signal (CLK) to divide the clock frequency;

2) commanding modules (e.g., master module 102) that will continue to operate in the power-saving mode but need to change their internal operation to suit the divided clock frequency to switch over to the divided clock mode;

3) completing all necessary memory access operations, which may include memory access operations executed by master module 102 as well as memory access operations executed by master module 101; and

4) completing all necessary central processing unit (CPU) operations, which may include CPU operations executed by master module 102 as well as CPU operations executed by master module 101.

These preparations take up the interval from time t₄ to time t₅. The power-saving mode starts at time t₅. Division of the frequency of the system clock (CLK) starts at time t₆. During the power-saving mode the whole system operates with reduced power consumption, and selected modules other than master module 101 may be halted completely.

Eventually, at time t₇, master module 102 needs to access the shared memory 103 and outputs bus request signal S13, which triggers a return to the normal clock frequency. In response to bus request signal S13, at time t₈ the bus arbiter 105 stops output of bus grant signal S12 to master module 101 and begins output of bus grant signal S14 to master module 102. In all, the duration T1 of the power-saving mode is from time t₅, when master module 101 completes the preparatory processing, to time t₈, when the bus arbiter 105 stops output of bus grant signal S12.

A problem with the system illustrated in FIGS. 6 and 7 is that to use the power-saving mode, master module 101 must monitor the status of the system and common bus 104, decide when the system can enter the power-saving mode, and carry out the preparatory processing outlined above. The preparatory processing is typically controlled by software instructions that must be read from memory and executed, which takes time. The monitoring and decision processes may also be controlled by software. Because of inevitable software processing delays, there is a considerable lag from the time at which the system could first enter the power-saving mode until the time when it actually does enter the power-saving mode (the interval from t₄ to t₅ in FIG. 7). The time spent in the power-saving mode (from t₅ to t₈) is correspondingly shortened. In the extreme case, all of the time available for power-saving operation (from t₄ to t₈) might be occupied with preparations, leaving no time for power-saving operation to take place.

Another type of system that experiences software delays in entering the power-saving mode is described in Japanese Patent Application Publication No. 2002-132394. The system has a multi-tasking microcomputer in which task execution is controlled by a real-time operating system. The task that switches the microcomputer from its normal mode to the power-saving mode has the lowest execution priority. This scheme simplifies the decision as to when the system is ready to operate in the power-saving mode, but multi-task control is an inherently complex process. Since the transition to the power-saving mode is controlled by a software task within a priority scheme that is also controlled by software (the operating system), entry to the power-saving mode still takes time.

### SUMMARY OF THE INVENTION

An object of the present invention is to increase the use of a power-saving function in a system employing bus arbitration.

The invented system operates in a normal mode and a power-saving mode. The system includes a bus, a memory connected to the bus, and at least one master module connected to the bus. Each master module outputs a bus request signal, receives a bus grant signal, and uses the bus to access the memory while the bus grant signal is active.

The bus request signals are received by a bus arbiter that generates the bus grant signals. The bus arbiter also generates an enable signal that can become active only when no bus grant signal is active.

The system further includes a power-down module that receives the enable signal from the bus arbiter and performs processing to take the system from the normal mode to the power-saving mode when the enable signal becomes active. This processing may include commanding a system clock control module to reduce the frequency of a system clock signal, or to halt the system clock signal altogether.

The system may recover from the power-saving mode to the normal mode when a master module still operating in the power-saving mode activates a bus request signal, or the recovery may be triggered by input of an external signal to the power-down module.

The bus arbiter may activate the enable signal whenever all bus request signals are inactive, or whenever all bus request signals are inactive and the memory is not being accessed, as indicated by an access information signal output from the memory to the bus arbiter.

By providing a separate power-down module to control the transition from the normal mode to the power-saving mode, instead of having the transition controlled by software in a master module, the invented system avoids the need to fetch power-down instructions from the memory, and can save power effectively by switching promptly into the power-saving mode during even short intervals in which the bus is idle.

### BRIEF DESCRIPTION OF THE DRAWINGS

In the attached drawings:

FIG. 1 is a block diagram of a system according to a first embodiment of the invention;

FIG. 2 is a more detailed block diagram showing the internal structure of the bus arbiter in FIG. 1;

FIG. 3 is a timing waveform diagram illustrating the operation of the first embodiment;

FIG. 4 is a block diagram of a system according to a second embodiment;

FIG. 5 is a timing waveform diagram illustrating the operation of the second embodiment;

FIG. 6 is a block diagram of a conventional system having a power-saving function; and

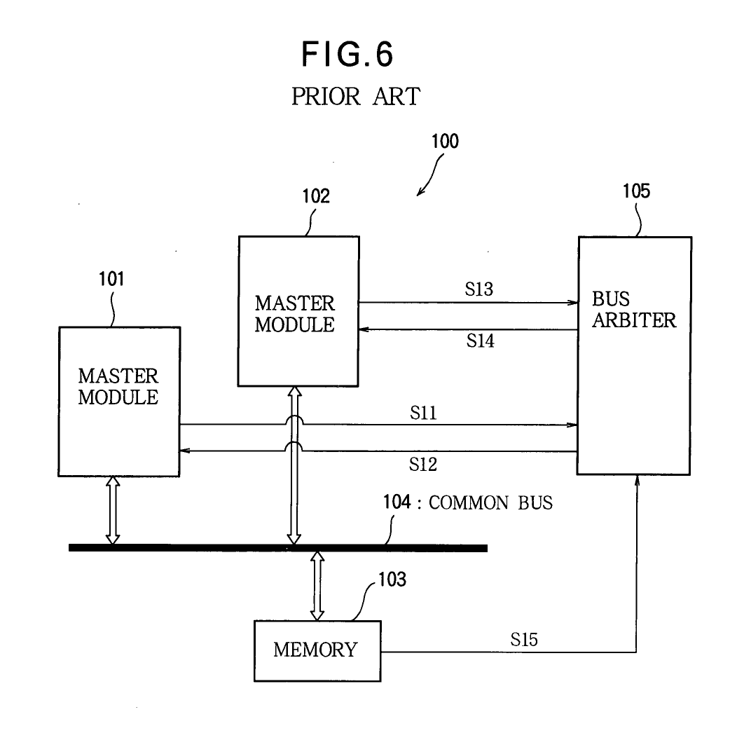

FIG. 7 is a timing waveform diagram illustrating the operation of the conventional system.

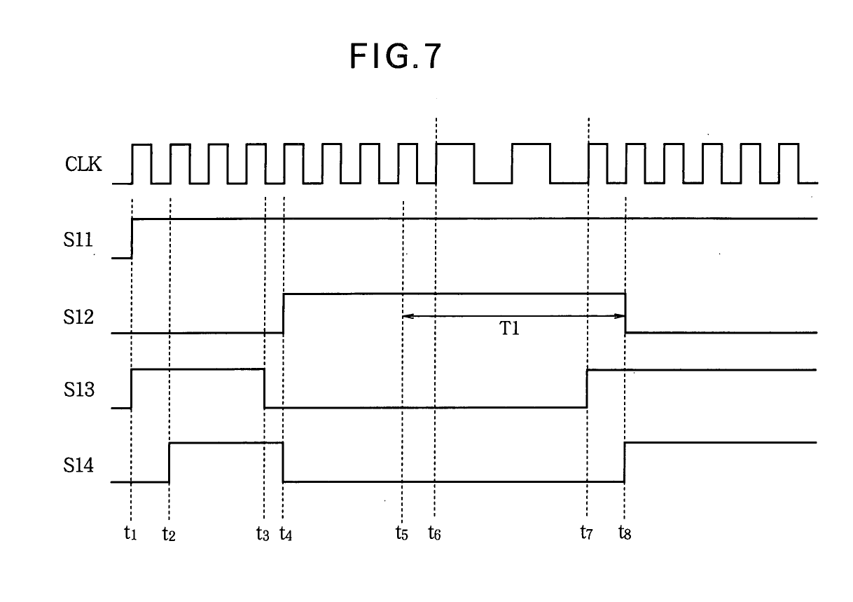

### DETAILED DESCRIPTION OF THE INVENTION

Embodiments of the invention will now be described with reference to the attached drawings, in which like elements are indicated by like reference characters.

### First Embodiment

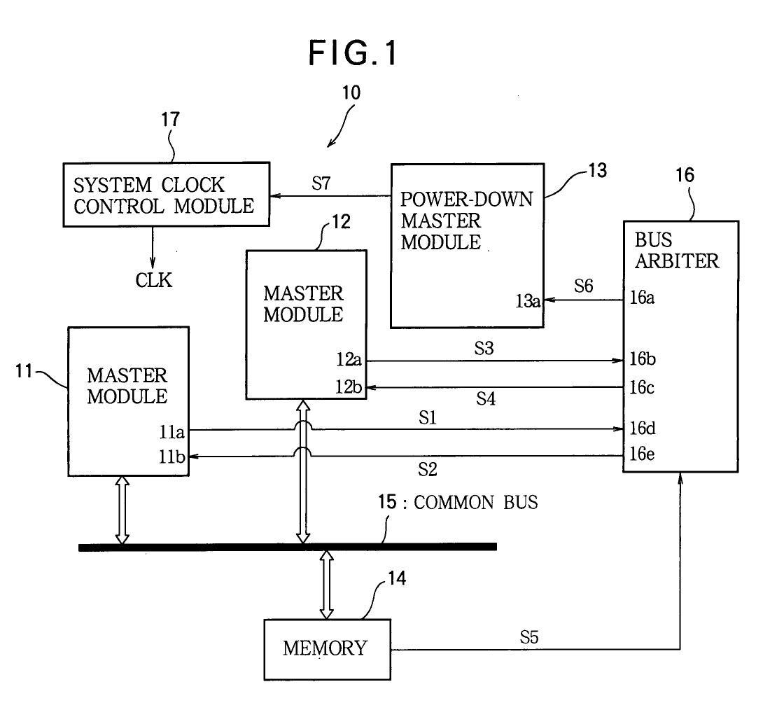

Referring to FIG. 1, the first embodiment is a system 10 including two master modules 11, 12, a power-down master module 13, a shared memory 14, a common bus 15, a bus arbiter 16, a system clock control module 17, and possibly other modules (not shown).

The common bus 15 is connected to the master modules 11, 12 and the memory 14. Master module 11 is the main master module but master module 12 has higher bus priority. Both master modules 11, 12 have control programs stored in internal memories (not shown) and can operate independently of the shared memory 14.

Master module 11 has an output port 11a connected to an input port 16d of the bus arbiter 16, and an input port 11b connected to an output port 16e of the bus arbiter 16. Master module 12 has an output port 12a connected to an input port 16b of the bus arbiter 16, and an input port 12b connected to an output port 16c of the bus arbiter 16. The power-down master module 13 has an input port 13a connected to an output port 16a of the bus arbiter 16. Master modules 11, 12 have, for example, a direct memory access (DMA) function that allows direct access to the shared memory 14 without involving their central processing units.

As in the conventional system, the master modules 11, 12 output respective bus request signals S1, S3 to the bus arbiter 16. The bus arbiter 16 outputs corresponding bus grant signals S2, S4 to the master modules 11, 12, and an enable signal S6 to the power-down master module 13. The shared memory 14 sends the bus arbiter 16 an access information signal S5 indicating whether the shared memory 14 is currently being accessed. The system clock control module 17 supplies a system clock CLK to all the master modules and the bus arbiter and divides the frequency of the system clock in response to a clock control signal S7 received from the power-down master module 13.

The main master module 11 always operates, but outputs bus request signal S1 only when necessary. The master modules 11, 12 output bus request signals S1, S3 when, for example, they need to read or write data in the shared memory 14 via the common bus 15. The bus arbiter 16 outputs bus grant signal S2 or S4, which gives the right to use the common bus 15, to the master module having the highest priority among the master modules requesting the bus right, according to criteria described below.

A master module that receives a bus grant signal performs necessary memory access operations or other operations involving the common bus 15. While memory access is in progress, the shared memory 14 activates the access information signal S5. The bus arbiter 16 outputs the enable signal S6 to the power-down master module 13 according to the criteria described below.

The power-down master module 13 does not access the shared memory 14, so it is not connected to the common bus 15. The power-down master module 13 receives the enable signal S6 from the bus arbiter 16 and executes processing to bring the system into a power-saving mode, as described later.

In the following description, the term ‘output’ is used in relation to the bus request signals S1, S3, bus grant signals S2, S4, access information signal S5, and enable signal S6 to mean that these signals S1, S2, S3, S4, S5, S6 are set to the high (H) logic level, which is their active level. The term ‘stop output’ is used to mean that these signals S1, S2, S3, S4, S5, S6 are set to the low (L) logic level, which is their inactive level.

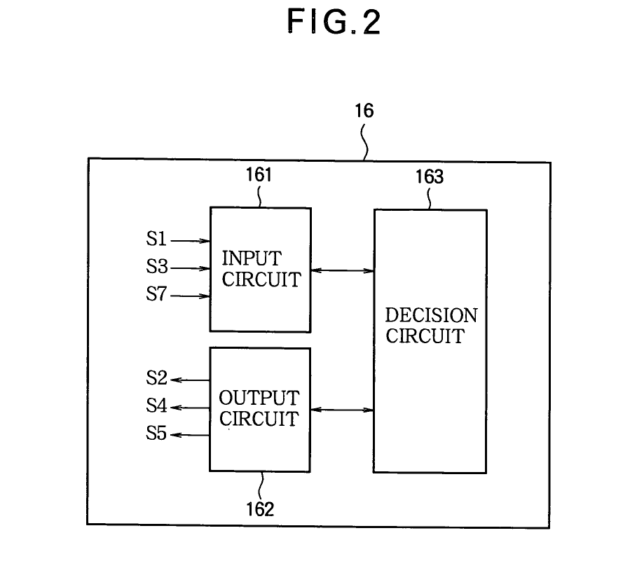

Referring to FIG. 2, the bus arbiter 16 includes an input circuit 161, an output circuit 162, and a decision circuit 163. The input circuit 161 receives the bus request signals S1, S3 from the master modules 11, 12 and the access information signal S5 from the shared memory 14, monitors whether each of these signals is at the high or low logic level, and sends this information to the decision circuit 163. The output circuit 162 outputs the bus grant signals S2, S4 and enable signal S6 to the master modules 11, 12 and power-down master module 13 on command from the decision circuit 163.

The decision circuit 163 commands the output circuit 162 to output the bus grant signals S2, S4 and enable signal S6 according to the following criteria.

1) If only bus request signal S1 is active (high), the output circuit 162 is commanded to output bus grant signal S2 but not bus grant signal S4.

2) If bus request signal S3 is active (high), the output circuit 162 is commanded to output bus grant signal S4 but not bus grant signal S2, regardless of the state of bus request signal S1.

3) When the access information signal S5 is active (high), indicating that memory access is in progress, the above criteria 1) and 2) are not acted on; they are tested and acted on only after completion of the current access.

4) When the bus request signals S1, S3 and access information signal S5 are all inactive (low), the output circuit 162 is commanded to output the enable signal S6 to the power-down master module 13.

These criteria give master module 12 the highest priority for receiving a signal (a bus grant signal) from the bus arbiter 16, while master module 11 has the next highest priority and the power-down master module 13 has the lowest priority. The bus arbiter 16 can generate the enable signal S6 by inverting the access information signal S5, treating the inverted access information signal as if it were a lowest-priority bus request signal, and treating the enable signal S6 as the corresponding bus grant signal. The enable signal S6 is output to the power-down master module 13 when the bus arbiter 16 recognizes that the shared memory 14 is not being accessed and that neither master module 11 or 12 has or is requesting the bus right. Accordingly, when the power-down master module 13 receives the enable signal S6, the conditions that permit the system 10 to enter the power-saving mode are automatically satisfied and do not need to be further monitored or checked.

When the power-down master module 13 receives the enable signal S6, it executes processes preparatory to placing the system in the power-saving mode. These preparatory processes include:

1) commanding the system clock control module 17 (by using the clock control signal S7) to divide the clock frequency; and

2) commanding any modules that will continue to operate in the power-saving mode and need to change their internal operation to suit the divided clock frequency to switch over to the divided clock mode.

These processes may be performed by hardware. The dividing of the clock frequency may be performed for the whole system or on an individual module basis. Input of the clock signal to selected modules other than the power-down master module 13 and bus arbiter 15 may also be halted, although at least one of the master modules 11, 12 must continue to operate.

Recovery from the power-saving mode to the normal mode is requested by output of bus request signal S1 or S3 from master module 11 or 12. This initiates a recovery process in which the system clock control module 17 stops dividing the clock frequency and the bus arbiter 16 grants the bus to the master module outputting the bus request signal.

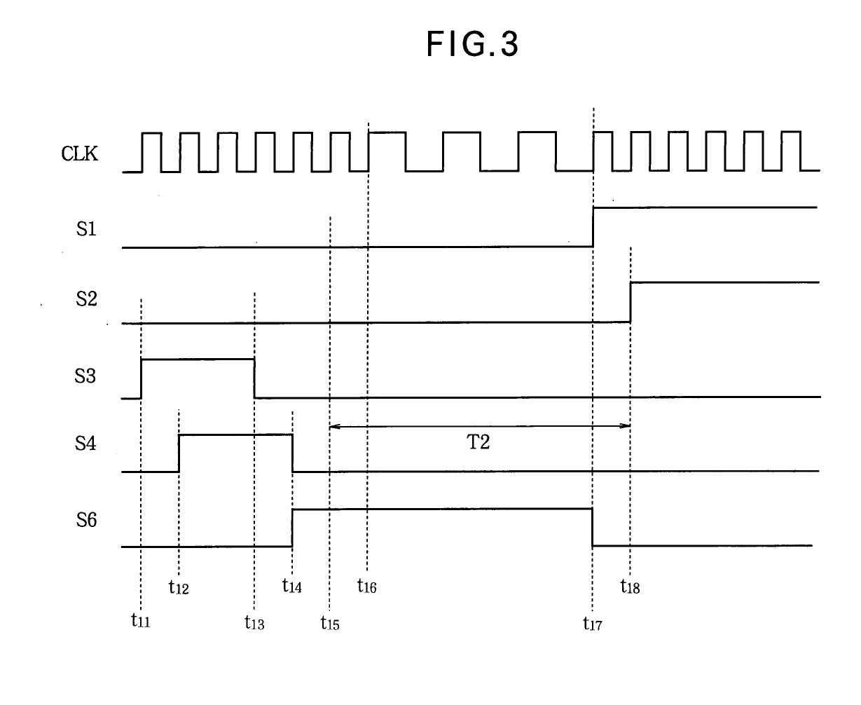

The operation of the system 10 will be described with reference to the exemplary timing shown in FIG. 3.

Master module 12 outputs bus request signal S3 at time t₁₁. The bus arbiter 16 outputs bus grant signal S4 at time t₁₂ to give master module 12 the right to use the common bus 15. Master module 12 uses the common bus 15 to access the shared memory 14, for example, and stops output of bus request signal S3 when the access is completed at time t₁₃.

In response to this signal transition, the bus arbiter 16 stops output of bus grant signal S4 at time t₁₄ and simultaneously begins output of the enable signal S6 to the power-down master module 13. Master module 12 occupies the common bus 15 from time t₁₂ to t₁₃. While it is performing memory access during this period, the access information signal S5 (not shown) is output.

In response to the enable signal S6, at time t₁₄ the power-down master module 13 begins the processes 1) and 2) described above. At time t₁₅ these processes are completed and the system enters the power-saving mode. Division of the clock (CLK) frequency starts at time t₁₆, and the whole system begins operating at a reduced and therefore power-saving clock rate. Master modules 11 and 12 both continue to operate without using the common bus 15.

Eventually, at time t₁₇, master module 11 needs to access the common bus 15. This need may arise from either hardware or software control. Master module 11 therefore outputs bus request signal S1. The bus arbiter 16 immediately stops output of the enable signal S6 to the power-down master module 13. In response to this signal transition, the power-down master module 13 sets the clock control signal S7 (not shown) to a state that commands the system clock control module 17 not to divide the clock frequency. The system clock control module 17 immediately resumes output of the clock signal CLK at its normal frequency. The bus arbiter 16 then outputs bus grant signal S2 to master module 11 at time t₁₈. The interval from time t₁₇ to time t₁₈ is a predetermined lag that provides time for the clock signal to return from the divided mode to the normal mode.

In the above sequence of operations, the duration of the power-saving mode is the period T2 extending from time t₁₅, when the power-down master module 13 completes the necessary preparatory processing, to time t₁₈, when the bus arbiter 16 outputs bus grant signal S2. Because of the reduced preparations, this period T2 is longer than the corresponding period T1 in the conventional system.

In the system 10 according to the first embodiment as described above, the following effects are obtained.

(1) Since the bus arbiter 16 outputs the enable signal S6 with lowest priority, whenever the power-down master module 13 receives the enable signal S6, the common bus 15 and the system 10 are automatically ready to enter the power-saving mode. Accordingly, the status of the common bus 15 and system 10 does not need to be monitored, the conventional monitoring hardware or software is not required, and the preparations for power-saving operation are shortened and simplified. The power-saving mode can therefore be entered more quickly than in the conventional system.

(2) Since the power-down master module 13 and bus arbiter 15 execute the recovery from the power-saving mode, neither master module 11 or 12 has to monitor the other master module's bus request signal in the power-saving mode.

(3) The novel power-down master module 13 is easy to design, because it can reuse software or hardware used to issue the commands that effect the transition to and recovery from the power-saving mode in the conventional system.

### Second Embodiment

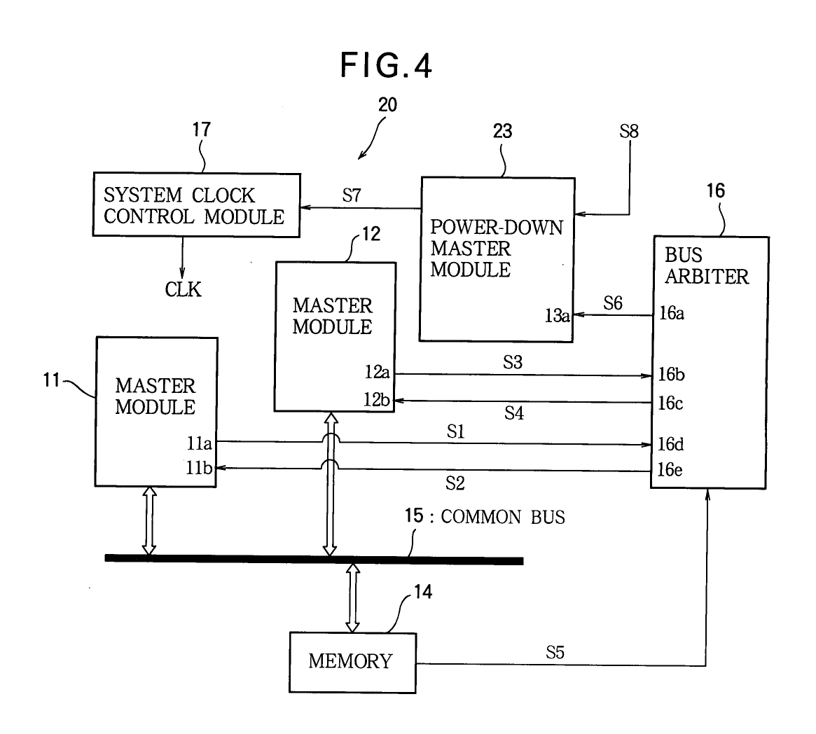

Referring to FIG. 4, the second embodiment is a system 20 in which the power-down master module 23 receives an external recovery request signal S8 that requests recovery from the power-saving mode. The other components 11, 12, 14, 15, 16, 17 are generally as described in the first embodiment. The following description will concentrate on the differences between the two embodiments.

As shown in FIG. 4, in the second embodiment the power-down master module 23 has an input port 23b to which the recovery request signal S8 is input from an external source (not shown) . The term ‘input’ will be used below to mean that the recovery request signal S8 is set to the high logic level, which is its active level. The recovery request signal S8 may be activated by an operator who operates an input panel (not shown). Input of the recovery request signal S8 causes the power-down master module 23 to execute the processing to return from the power-saving mode to the normal mode.

The system clock control module 17 in the system 20 in the second embodiment can divide the clock frequency as in the first embodiment, and can also stop clock output completely, depending on the value of the clock control signal S7 received from the power-down master module 23. When the power-down master module 23 receives the enable signal S6 from the bus arbiter 16, it performs the processes 1) and 2) described above to place the system in the power-saving mode, but in the second embodiment process 1) may command the system clock control module 17 to divide the clock frequency or stop clock output altogether. In either case, when the power-down master module 23 receives the recovery request signal S8 during the power-saving mode, it sets the clock control signal S7 to a value that commands the system clock control module 17 to resume output of the clock signal at the normal frequency. The power-down master module 23 has hardware to carry out this function when the clock is stopped.

Even if the clock signal provided to the whole system is stopped in the power-saving mode, since normal clock output resumes on exit from the power-saving mode, after recovery to the normal mode, either master module 11 or 12 can receive the right to access the common bus 15. Granting the bus right is at the discretion of the bus arbiter 16; the decision is made by the decision circuit 163 in the bus arbiter 16 (shown in FIG. 2) according to the criteria 1) to 4) described in the first embodiment. Repeated descriptions will be omitted.

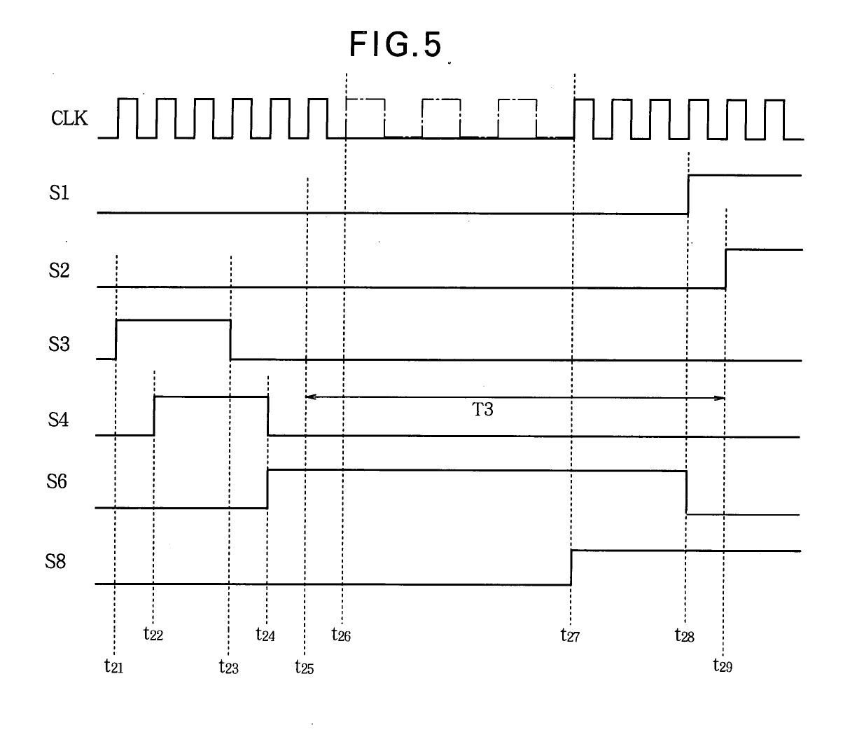

The operation of the system 20 will be described below with reference to the exemplary timing shown in FIG. 5.

Master module 12 outputs bus request signal S3 at time t₂₁. The bus arbiter 16 outputs bus grant signal S4 to master module 12 at time t₂₂, giving master module 12 the right to use the common bus 15. Master module 12 executes necessary operations such as memory access, after which it stops output of bus request signal S3 at time t₂₃. In response, the bus arbiter 16 stops output of bus grant signal S4 at time t₂₄ and begins output of the enable signal S6 to the power-down master module 23. Master module 12 thus occupies the common bus 15 from time t₂₂ to time t₂₃. During this period, when master module 12 performs memory access the shared memory 14 outputs the access information signal S5 (not shown).

The power-down master module 23 starts the processes that prepare for power-saving operation at time t₂₄ and completes these processes at time t₂₅, after which the system enters the power-saving mode. Immediately after having entered the power-saving mode, at time t₂₆ the system clock signal (CLK) is stopped or its frequency is divided and the whole system is brought into the power-saving mode. The solid line FIG. 5 indicates the case in which the clock signal CLK is stopped; the dash-dot line indicates the case in which the clock frequency is divided. It will be assumed in the following description that the clock signal CLK is stopped in the power-saving mode.

Eventually, at time t₂₇, the power-down master module 23 receives the external recovery request signal S8. Hardware in the power-down master module 23 responds by setting the clock control signal S7 to the state that commands the system clock control module 17 to return the clock signal CLK to its normal frequency. If the clock signal CLK was stopped, the system 20 restarts at this point from the state in which it stopped at time t₂₆. Awhile later, at time t₂₈, master module 11 needs to access the shared memory 14 again. As in the first embodiment, this need may arise from either software or hardware (e.g., an interrupt). Master module 11 therefore outputs bus request signal S1, and the bus arbiter 16 immediately stops output of the enable signal S6 to the power-down master module 23. Next, at time t₂₉, the bus arbiter 16 outputs bus grant signal S2 to master module 11.

In the above sequence of operations, the power-saving mode period T3 extends from time t₂₅, at which the power-down master module 23 completes the process of initiating the power-saving mode, to time t₂₉, at which the bus arbiter 16 outputs bus grant signal S2.

If the system clock CLK is stopped during the power-saving mode as in the description above, recovery to the normal mode can only occur in response to input of the recovery request signal S8. If output of the clock signal CLK continues during the power-saving mode with a divided clock frequency, however, recovery to the normal mode can occur either in response to input of the recovery request signal S8 or in response to a bus request signal S1 or S3 output from master module 11 or 12 as in the first embodiment.

In the system 20 according to the second embodiment as described above, the following effects are obtained.

(1) As in the first embodiment, when the power-down master module 23 receives the enable signal S6, the common bus 15 and the system 20 are automatically ready to enter the power-saving mode. Accordingly, the status of the common bus 15 and system 20 does not need to be monitored, the conventional monitoring hardware or software is not required, and the preparations for power-saving operation are shortened and simplified. The power-saving mode can therefore be entered quickly.

(2) Since the power-down master module 23 initiates the process of recovery from the power-saving mode in response to the external recovery request signal, neither master module 11 or 12 has to remain active in the power-saving mode. Therefore, it is possible to stop the supply of the clock signal to both master modules 11, 12 during the power-saving mode, achieving an increased reduction in system power consumption.

(3) The power-down master module 13 is easy to design, because it can reuse software or hardware conventionally used to issue the commands that effect the transition to and recovery from the power-saving mode.

The invention is not limited to the preceding embodiments. Those skilled in the art will recognize that further variations are possible within the scope of the invention, which is defined in the appended claims.

What is claimed is:

1. A system including a bus and a memory connected to the bus, the system operating in a normal mode and a power-saving mode, the system comprising:
at least one master module connected to the bus, generating a bus request signal, receiving a bus grant signal, and using the bus to access the memory while the bus grant signal is active;
a bus arbiter receiving the bus request signal from each said master module, generating the bus grant signal for each said master module, and generating an enable signal that is active only when no bus grant signal is active; and
a power-down module receiving the enable signal from the bus arbiter and performing processing to take the system from the normal mode to the power-saving mode when the enable signal becomes active.

2. The system of claim 1, wherein the power-down module performs the processing to take the system from the normal mode to the power-saving mode by hardware.

3. The system of claim 1, wherein the power-down module also performs processing to return from the power-saving mode to the normal mode.

4. The system of claim 3, wherein the power-down module performs the processing to return from the power-saving mode to the normal mode by hardware.

5. The system of claim 3, wherein the power-down module performs the processing to return from the power-saving mode to the normal mode in response to an external signal.

6. The system of claim 3, wherein the power-down module performs the processing to return from the power-saving mode to the normal mode in response to output of said bus request signal by any said master module.

7. The system of claim 6, wherein:
the bus arbiter holds the enable signal active in the power-saving mode until reception of said bus request signal from any said master module; and
the power-down module performs the processing to return from the power-saving mode to the normal mode in response to deactivation of the enable signal by the bus arbiter in the power-saving mode.

8. The system of claim 1, further comprising a system clock control module controlling a system clock signal with which operation of the system is synchronized, wherein the processing performed by the power-down module to take the system from the normal mode to the power-saving mode includes commanding the system clock control module to reduce a frequency of the system clock signal.

9. The system of claim 8, wherein the power-down module commands the clock control module to divide the frequency of the clock signal.

10. The system of claim 1, further comprising a system clock control module generating a system clock with which operation of the system is synchronized, wherein the processing performed by the power-down module to take the system from the normal mode to the power-saving mode includes commanding the system clock control module to halt the system clock signal.

11. The system of claim 1, wherein the bus arbiter activates the enable signal whenever every said bus request signal is inactive.

12. The system of claim 1, wherein the memory generates an access information signal indicating whether the memory is being accessed, and the bus arbiter activates the enable signal when every said bus request signal is inactive and the access information signal indicates that the memory is not being accessed.

13. The system of claim 1, wherein the bus arbiter operates according to a priority scheme in which the enable signal has lowest output priority.
